(19) United States
(12) Patent Application Publication
(10) Pub. No.: US 2009/0276448 A1
(43) Pub. Date: Nov. 5, 2009

(54) PARALLEL TRANSFORMATION OF FILES

(75) Inventor: Andrew J. Coleman, Petersfield (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/112,923

(22) Filed: Apr. 30, 2008

(51) Int. Cl. G06F 17/30

(52) U.S. Cl. 707/101; 707/E17.009

(57) ABSTRACT

A message brokering system includes a file input node configured to receive a file and divide the received file into a plurality of file portions for processing in the message brokering system, a plurality of transformation nodes configured to transform the plurality of file portions independently and in parallel, and a collector node configured to collect the plurality of transformed file portions and combine the plurality of transformed file portions into a single combined file based on header information associated with each of the plurality of file portions. The file input node is configured to divide the received file based on at least one user-configurable attribute, and the file input node is configure to associate the header information with the received file or each file portion of the plurality of file portions.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to file processing. More particularly, this invention relates to an efficient method for parallel transformation of files.

2. Description of Background

Generally, message processing in a broker or enterprise service bus message broker (ESB) involves routing and/or transformation. The content of the input message may be used to determine the content or destination of the output. Traditionally, this may be performed one message at a time, where the content of each message is considered in isolation.

### SUMMARY

A message brokering system includes a file input node configured to receive a file and divide the received file into a plurality of file portions for processing in the message brokering system, a plurality of transformation nodes configured to transform the plurality of file portions independently and in parallel, and a collector node configured to collect the plurality of transformed file portions and combine the plurality of transformed file portions into a single combined file based on header information associated with each of the plurality of file portions. The file input node is configured to divide the received file based on at least one user-configurable attribute, and the file input node is configure to associate the header information with the received file or each file portion of the plurality of file portions.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a message broker system, according to an example embodiment;

FIG. 2 illustrates a method of message brokering, according to an example embodiment; and

FIG. 3 illustrates a computer apparatus, according to an example embodiment.

The detailed description explains an exemplary embodiment, together with advantages and features, by way of example with reference to the drawings.

### DETAILED DESCRIPTION

According to an exemplary embodiment, a system and methodology is provided which significantly increases the simplicity of brokering large messages in a computer system.

According to an example embodiment, a method of brokering messages includes parallel transformation of large files according to desired settings (e.g., fixed-length, delimited portions, repeating fields, etc). Each portion of the file is propagated through a message brokering system using available threads from a managed thread pool. Each portion of the file is transformed independently, and routed to a collector node. The collector node combines portions of the same message (i.e., from the same file) and builds a single message from the different portions. According to example embodiments, multiple messages may be combined at the collector, thereby allowing different files to be transformed into messages concurrently.

Additionally, according to an example embodiment, a message brokering system is provided. The message brokering system includes a file input node configured to receive a file and divide the received file into a plurality of file portions for processing in the message brokering system, a plurality of transformation nodes configured to transform the plurality of file portions independently and in parallel, and a collector node configured to collect the plurality of transformed file portions and combine the plurality of transformed file portions into a single combined file based on header information associated with each of the plurality of file portions. The file input node is configured to divide the received file based on at least one user-configurable attribute, and the file input node is configured to associate the header information with the received file or each file portion of the plurality of file portions.

A message broker or message brokering system is generally a backbone of a computer system which converts messages/files to formats suitable for different applications of a computer system. A message broker may create artifacts to control messages, may understand formats for applications of the computer system, and may include a node to route messages.

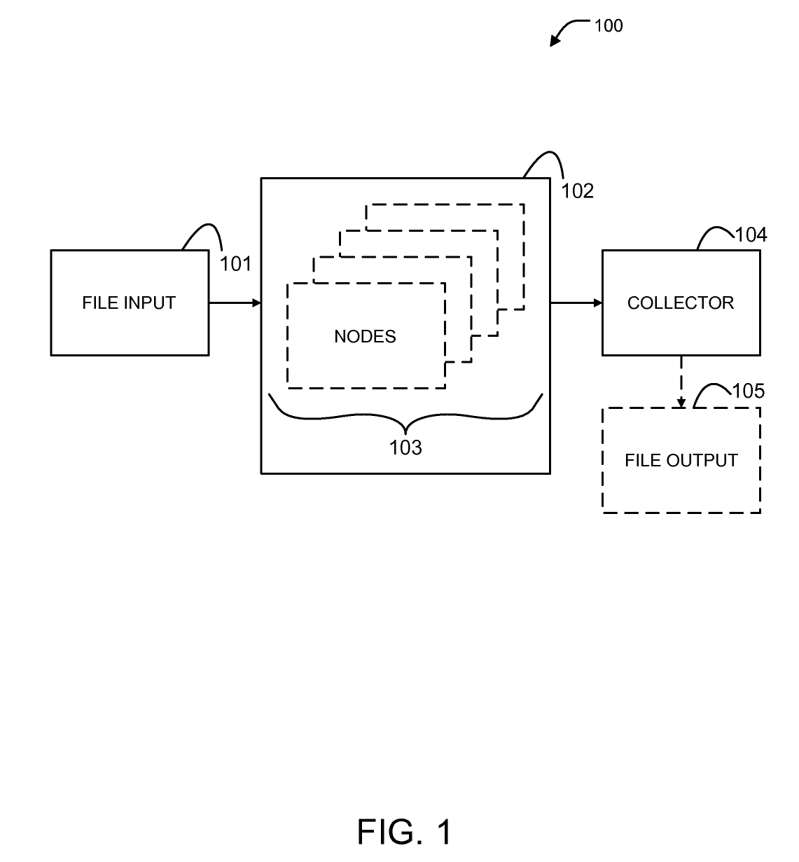

Turning to FIG. 1, a message broker system is illustrated according to an example embodiment. The system 100 includes file input node 101. The file input node 101 may receive files or message of a computer system. The file input node 101 may be configured to shred a file, for example a large file, into different portions according to desired settings. For example, the desired settings may be user-configurable settings including, but not limited to, fixed-length of portions, delimited portions, and/or repeating fields of the file/message. The file input node 101 may append/add file information to headers of the file shreds. For example, the file input node 101 may receive a file, append file information to a header of the file, and shred the file into different portions with each portion, where each portion includes header information appended thereto. Alternatively, the file input node 101 may be configured to append file information to each shred after shredding the received file.

System 100 further includes transformation portion 102. The portion 102 may include transformation nodes 103. It is noted that example embodiments should not be limited to any particular number of transformation nodes. The transformation nodes 103 may be configured to receive different portions of shredded files. For example, each node of the transformation nodes 103 may receive a different shred of a single file, or a different shred of multiple shredded files. Each transformation node of nodes 103 may be configured to transform each shred independently.

The system 100 further includes collector node 104. The collector node 104 may be configured to collect transformed portions of the file. For example, transformation nodes 103 may independently transform shred of a file and transmit the transformed portions (including header information) to the collector node 104. The collector node 104 may organize the transformed shreds based on header information, and may produce a single message or file from shreds with similar header information.

System 100 further includes output node/file output node 105. For example, the collector node 104 may output a reconstructed message/file to file output node 105 for transmission to a remote system or to other applications of a computer system.

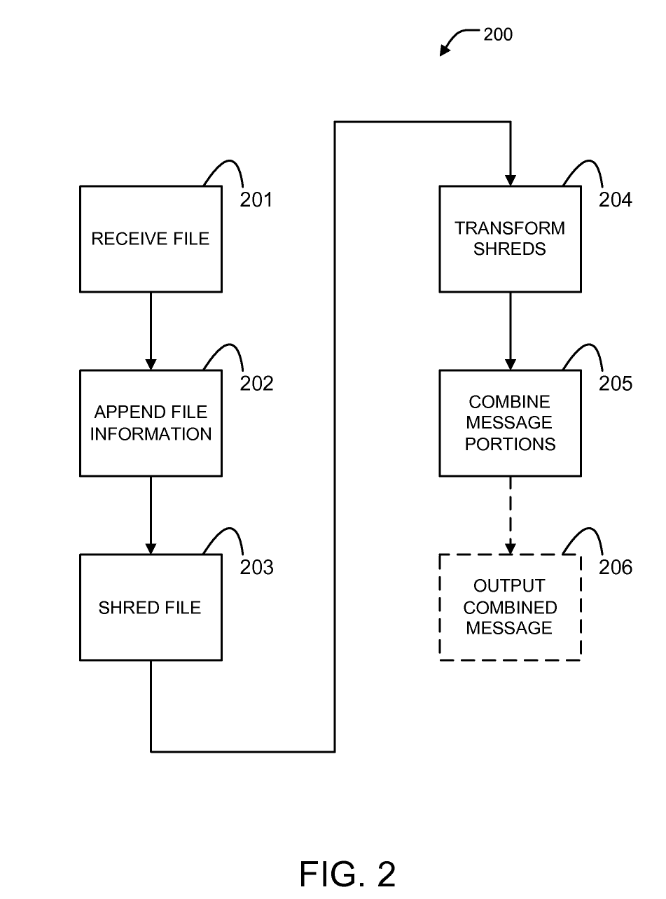

It is noted that system 100 may be employed within a computer system as noted above. Therefore, the files processed by system 100 may be retrieved from within the computer system. Further, a message brokering system similar to system 100 may be configured to perform a methodology of message brokering as described herein, and may broker messages through the computing system. Turning to FIG. 2, a method of message brokering according to an example embodiment is illustrated.

The method 200 includes receiving a file at block 201. For example, a file of a computer system to be distributed to an application may be received. The method further includes appending file information at block 202. The file information related to the received file may be appended as, or be transferred to, a header for the received file. The method 200 further includes shredding a file at block 203. For example, the received file (including header information) may be shredded into different portions for parallel transformation. It is noted that as an alternative, the method may include shredding the received file first, and appending file information thereafter to each of the shreds.

The method 200 further includes transforming the file shreds at block 204. For example, each shred of the received file may be transformed at different transformation nodes of a message brokering system. The transformation of each shred may occur independently at different nodes. Further, shreds from more than one file may be transformed in parallel. Upon transformation into message portions, the method 200 includes combining message portions at block 205. For example, a collector node of a brokering system may collect the transformed file shreds and combine the shreds into a single message based on the associated header information. Thereafter, a single combined message may be output at block 206.

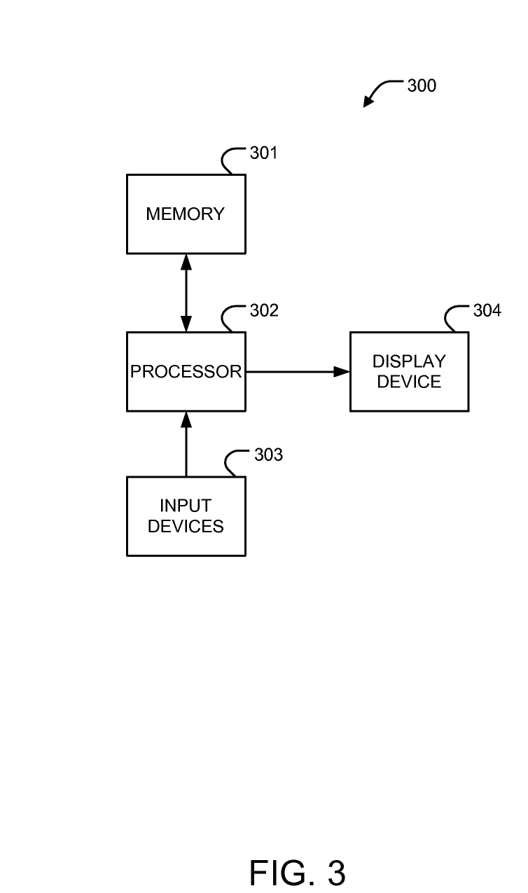

Furthermore, according to an exemplary embodiment, the methodologies described hereinbefore may be implemented by a computer system or apparatus. For example, FIG. 3 illustrates a computer apparatus, according to an exemplary embodiment. Therefore, portions or the entirety of the methodologies described herein may be executed as instructions in a processor 302 of the computer system 300. The computer system 300 includes memory 301 for storage of instructions and information, input device(s) 303 for computer communication, and display device 304. Thus, the present invention may be implemented, in software, for example, as any suitable computer program on a computer system somewhat similar to computer system 300. For example, a program in accordance with the present invention may be a computer program product causing a computer to execute the example methods described herein.

The computer program product may include a computer-readable medium having computer program logic or code portions embodied thereon for enabling a processor (e.g., 302) of a computer apparatus (e.g., 300) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

With an exemplary embodiment of the present invention having thus been described, it will be obvious that the same may be varied in many ways. The description of the invention hereinbefore uses this example, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

What is claimed is:

1. A message brokering system, comprising:
a file input node configured to receive a file and divide the received file into a plurality of file portions for processing in the message brokering system;
a plurality of transformation nodes configured to transform the plurality of file portions independently and in parallel; and
a collector node configured to collect the plurality of transformed file portions and combine the plurality of transformed file portions into a single combined file based on header information associated with each of the plurality of file portions; wherein,
the file input node is configured to divide the received file based on at least one user-configurable attribute; and
the file input node is configured to associate the header information with the received file or each file portion of the plurality of file portions.

2. The system of claim 1, further comprising:
a file output node configured to output the single combined file to an appropriate application residing on the computer system, wherein,
the plurality of transformation nodes is configured to transform each file portion of the plurality of file portions into a format suitable for the appropriate application.

3. The system of claim 1, wherein the at least one user-configurable attribute includes one of:
dividing the received file based on fixed length of file portions;
dividing the received file based on delimited separations within the received file; and
dividing the file based on repeating fields of the received file.
